(19) United States
(12) Patent Application Publication
(10) Pub. No.: US 2017/0314378 A1
(43) Pub. Date: Nov. 2, 2017

(54) METHOD FOR FORMING A GAS PHASE IN WATER SATURATED HYDROCARBON RESERVOIRS

(71) Applicants: HIGHLANDS NATURAL RESOURCES, PLC, Beckenham (GB); DIVERSION TECHNOLOGIES, LLC, Castle Rock, CO (US)

(72) Inventor: Paul E. Mendell, Castle Rock, CO (US)

(73) Assignees: HIGHLANDS NATURAL RESOURCES, PLC, Beckenham (GB); DIVERSION TECHNOLOGIES, LLC, Castle Rock, CO (US)

(21) Appl. No.: 15/590,230

(22) Filed: May 9, 2017

Related U.S. Application Data
(63) Continuation of application No. 15/499,420, filed on Apr. 27, 2017.
(60) Provisional application No. 62/328,405, filed on Apr. 27, 2016.

(51) Int. Cl. E21B 43/25; C10G 33/04; B01D 53/26

(52) U.S. Cl. CPC E21B 43/255; B01D 53/26; C10G 33/04

(57) ABSTRACT

The present disclosure describes a method of recovering oil and gas from a hydrocarbon-containing reservoir generally having some degree of water saturation within the reservoir pore network by injecting a gas into the reservoir. The method applicable to reservoirs having high water saturation of about 50 percent or greater. High water saturation in a reservoir can cause excessive amounts of water to be produced to produce the hydrocarbons. Coproduction and management of this water is costly and burdensome to operations leaving many reservoirs of oil and gas are stranded, rendering the production uneconomic. The method described herein addresses this need and other needs. The injection gas (with or without other hydrocarbons) can coalesce with the hydrocarbons contained within the hydrocarbon-containing reservoir to form a continuous phase of hydrocarbons within the reservoir. Once the targeted volume of the injection gas is injected, the flow is reversed producing the gathered hydrocarbons.

### CROSS REFERENCE TO RELATED APPLICATIONS

The present application is a continuation application of and claims priority to U.S. application Ser. No. 15/499,420, which was filed on Apr. 27, 2017, entitled “Method for Forming a Gas Phase in Water Saturated Hydrocarbon Reservoirs which claims priority under 35 U.S.C. §119 to U.S. Provisional Patent Application No. 62/328,405, which was filed Apr. 27, 2016, entitled “Method for Forming a Gas Phase in Water Saturated Hydrocarbon Reservoirs,” which is incorporated in its entirety herein by this reference.

### FIELD

The following disclosure relates generally to production of hydrocarbons from a subterranean hydrocarbon-containing reservoir, more particularly to production of hydrocarbons from a water saturated subterranean hydrocarbon-containing reservoir.

### BACKGROUND

Oil and gas reservoirs generally have some degree of water saturation within the pore network. Many reservoirs of natural gas and oil throughout the world have high water saturation (50 percent or greater). Even reservoirs which produce water-free, or produce only modest volumes of water, may have up to 60% or more, water saturation. High water saturation in a reservoir causes excessive amounts of water to be produced to produce the hydrocarbons. Coproduction and management of this water is costly and burdensome to operations leaving many reservoirs of oil and gas, stranded as uneconomic. Additionally, many hydrocarbon plays that require large volumes of water to be managed (such as the Mississippi Lime play in Kansas and Oklahoma), require expensive deep injection well facilities. Some of these operations are believed to be responsible for recent earthquake activity and the cause of production curtailments mandated by regulators, imposed on the industry. In some cases, like these, millions of barrels of water are produced to recover oil and gas that otherwise would remain in the ground. The reverse of these conditions can also be true, where reservoirs with relatively high gas or oil saturation, produce excessive volumes of water. The present invention is a method of recovering oil and gas from reservoirs with a relatively significant oil and/or gas saturation, but under normal producing operations, produce excessive volumes of water.

### SUMMARY

These and other needs are addressed by the present disclosure. Aspects of the present disclosure can have advantages over current practices.

The present disclosure provides a method that can include the steps: providing a provided gas, injecting the provided gas into a hydrocarbon-containing reservoir, ceasing the injection of the provided gas, and gathering from the hydrocarbon-containing reservoir a mixture of the provided gas and some of the gaseous hydrocarbons from the hydrocarbon-containing reservoir.

The hydrocarbon-containing reservoir commonly has a moveable water saturation value from about 15% to about 90.

The hydrocarbon-containing reservoir can comprise a gaseous hydrocarbon having a carbon backbone from about one to about four carbon atoms.

The provided gas can be injected at rate of from about 10 mcfd or more to about no more than about 8,000 mcfd. Commonly, the provided gas is typically injected for a period from about five days to about three months.

The gather gas can comprise a mixture of the provided gas and the gaseous hydrocarbons having from about 2 to about 98 volume % of the provided gas and from about 98 to about 2 volume % the gaseous hydrocarbon.

The provided gas injected into the hydrocarbon-containing reservoir can be selected from the group consisting essentially of methane, ethane, propane, nitrogen, butane, air, oxygen, argon, carbon dioxide, helium or mixture thereof.

The hydrocarbon-containing reservoir can comprise, prior to the injecting of the provided gas, a plurality of discrete hydrocarbon phases. The plurality of discrete hydrocarbon phases can be in the form of one or more pockets and bubbles of hydrocarbons. The injecting of the provided gas can coalesce the one or more of the plurality of discrete hydrocarbon phases into one or more continuous hydrocarbon phases. The injection of the provided gas can reduce the level of water saturation from about 5 to about 95%.

The gathering step can be continued until one or more of the following is true: (i) the production of the mixture of the provided gas and some of the gaseous hydrocarbons from the hydrocarbon-containing reservoir ceases; and (ii) the hydrocarbon-containing reservoir becomes water saturated and produces primarily water. The provided gas can be one of air, nitrogen, methane, or a mixture thereof. The gaseous hydrocarbon gas can comprise methane.

In accordance with the present disclosure, a method can include the steps: providing a provided gas, injecting the provided gas into a well bore, ceasing the injection of the provided gas, and producing from the wellbore a mixture of the provided gas and some of the gaseous hydrocarbons from the hydrocarbon-containing reservoir. The wellbore can traverse a hydrocarbon-containing reservoir having a moveable water saturation value from about 5% to about 95%. Moreover, the hydrocarbon-containing reservoir can typically comprise a gaseous hydrocarbon having a carbon backbone of about one to about four carbon atoms.

The gather gas can comprise a mixture of the provided gas and the gaseous hydrocarbons having from about 2 to about 98 volume % the provided gas and from about 98 to about 2 volume % the gaseous hydrocarbon.

Typically, the hydrocarbon-containing reservoir can have pore volumes having a porosity and permeability. The hydrocarbon-containing reservoir can have, prior to the injecting of the provided gas, a plurality of discrete hydrocarbon phases contained within the pore volumes. The injecting of the provided gas can coalesce the one or more of the plurality of discrete hydrocarbon phases into one or more continuous hydrocarbon phases. The one or more continuous hydrocarbon phases can span three or more pore volumes.

The injection of the provided gas can reduce the level of water saturation from about 2 to about 98%. The provided gas injected into the hydrocarbon-containing reservoir can be one of methane, ethane, propane, nitrogen, butane, air, oxygen, argon, carbon dioxide, helium or mixture thereof. The injecting of the gas into the wellbore is generally at a pressure below the fracture press of the hydrocarbon-containing reservoir.

Commonly, the producing step can be continued until one or more of the following is true: (i) the production of the mixture of the provided gas and some of the gaseous hydrocarbons from the hydrocarbon-containing reservoir ceases; and (ii) the hydrocarbon-containing reservoir becomes water saturated and produces primarily water. The provided gas is typically injected into the hydrocarbon-containing reservoir at rate of from about 10 mcfd or more to about no more than about 1,000 mcfd. The injecting of the provided gas can be for a period from about five days to about three months.

The present disclosure provides a method that can include the steps: providing a provided gas, injecting the provided gas into a well bore, producing, after the ceasing of the injection of the provided gas, from the wellbore a mixture of the provided gas and some of the gaseous hydrocarbons from the hydrocarbon-containing reservoir. The wellbore typically traverses a hydrocarbon-containing reservoir comprising a gaseous hydrocarbon having a carbon backbone of about one to about two carbon atoms. The provided gas is generally injected at rate of from about 10 mcfd or more to about no more than about 8,000 mcfd. The injecting of the provided gas can be for a period from about five days to about three months. Moreover, the gather gas can usually comprise a mixture the provided gas and the gaseous hydrocarbons having from about 2 to about 98 volume % the provided gas and from about 98 to about 2 volume % the gaseous hydrocarbon. The hydrocarbon-containing reservoir can have a moveable water saturation value from about 5% to about 95%. The provided gas injected into the hydrocarbon-containing reservoir can be one of methane, ethane, propane, nitrogen, butane, air, oxygen, carbon dioxide, helium or mixture thereof. The injecting of the provided gas into the wellbore can be at a pressure below the fracture press of the hydrocarbon-containing reservoir.

The present disclosure provides a method that includes the steps: providing a provided gas, injecting the provided gas into a hydrocarbon-containing reservoir having a first water to gas production ratio, ceasing the injection of the provided gas, and gathering from the hydrocarbon-containing reservoir a gathered-gas mixture comprising the provided gas and some of the gaseous hydrocarbons from the hydrocarbon-containing reservoir. The hydrocarbon-containing reservoir can comprise a gaseous hydrocarbon. Moreover, the provided gas can typically be injected at rate of from about 10 mcfd or more to about no more than about 8,000 mcfd. The hydrocarbon-containing reservoir producing the gathered-gas mixture can commonly have a second water to gas production ratio and wherein the second water-to-gas ratio is no more than the first water-to-gas ratio. The provided gas injected into the hydrocarbon-containing reservoir can be selected from the group consisting essentially of methane, ethane, propane, nitrogen, butane, air, oxygen, argon, carbon dioxide, helium or mixture thereof. The hydrocarbon-containing reservoir can commonly have, prior to the injecting of the provided gas, a plurality of discrete hydrocarbon phases. The plurality of discrete hydrocarbon phases can usually be in the form of one or more pockets and bubbles of hydrocarbons. The injecting of the provided gas can coalesce the one or more of the plurality of discrete hydrocarbon phases into one or more continuous hydrocarbon phases. The gather gas mixture can comprise the provided gas and the gaseous hydrocarbons having from about 2 to about 98 volume % the provided gas and from about 98 to about 2 volume % the gaseous hydrocarbon. The gaseous hydrocarbon can comprise one of methane, ethane, propane, n-butane, isobutane, ethylene, propylene, 1-butene, and mixture thereof. The first water to gaseous hydrocarbon is commonly from about 1 bbl water/1000 MCF to about 2000 bbl water/1000 MCF. The second water to gaseous hydrocarbon ratio is generally from about 98% to about 2% of first water to gaseous hydrocarbon ratio. The injecting of the provided gas is typically for a period from about five days to about three months. Generally, the gaseous hydrocarbon gas can comprise methane.

The present disclosure provides a method that can include the steps: providing a well having first water to gas production ratio. providing a provided gas, injecting the provided gas into a well bore, ceasing the injection of the provided gas, and producing from the wellbore a mixture of the provided gas and some of the gaseous hydrocarbons having a second water to gas production ratio. The wellbore typically traverses a hydrocarbon-containing reservoir. The hydrocarbon-containing reservoir can comprise a gaseous hydrocarbon. The first water-to-gas ratio is usually greater than the second water-to-gas ratio. The hydrocarbon-containing reservoir can have pore volumes having a porosity and permeability. The hydrocarbon-containing reservoir can have, prior to the injecting of the provided gas, a plurality of discrete hydrocarbon phases contained within the pore volumes. The injecting of the provided gas can coalesce the one or more of the plurality of discrete hydrocarbon phases into one or more continuous hydrocarbon phases. Generally, the one or more continuous hydrocarbon phases can span three or more pore volumes. Typically, the gaseous hydrocarbon can comprise one of methane, ethane, propane, n-butane, isobutane, ethylene, propylene, 1-butene, and mixture thereof. Commonly, the first water to gaseous hydrocarbon can be from about 1 bbl water/1000 MCF to about 2000 bbl water/1000 MCF. Generally, the provided gas injected into the hydrocarbon-containing reservoir can be one of methane, ethane, propane, nitrogen, butane, air, oxygen, argon, carbon dioxide, helium or mixture thereof. Typically, the injecting of the gas into the wellbore can be at a pressure below the fracture press of the hydrocarbon-containing reservoir. The second water to gaseous hydrocarbon ratio can be from about 98% to about 2% of first water to gaseous hydrocarbon ratio. The mixture of the provided gas and some of the gaseous hydrocarbons can have from about 2 to about 98 volume % the provided gas and from about 98 to about 2 volume % the gaseous hydrocarbon. Commonly, the injecting of the provided gas can be for a period from about five days to about three months.

The present disclosure can provide a method that can include the steps: providing a target well having a first water to gas production ratio from about 1 bbl water/1000 MCF to about 2000 bbl water/1000 MCF, providing a provided gas, injecting the provided gas into a well bore, and producing, after the ceasing of the injection of the provided gas, from the target well at a second water to gaseous hydrocarbon ration. The wellbore usually traverses the hydrocarbon-containing reservoir. The provided gas is typically injected at a rate of from about 10 mcfd or more to about no more than about 8,000 mcfd. The second water to gaseous hydrocarbon ratio is commonly from about 98% to about 2% of first water to gas production ratio. The provided gas injected into the hydrocarbon-containing reservoir can be one of methane, ethane, propane, nitrogen, butane, air, oxygen, argon, carbon dioxide, helium or mixture thereof. The injecting of the provided gas into the wellbore can be at a pressure below the fracture press of the hydrocarbon-containing reservoir.

A number of variations and modifications of the disclosure can be used. It would be possible to provide for some features of the disclosure without providing others.

These and other advantages will be apparent from the disclosure of the aspects, embodiments, and configurations contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, the phrase “gaseous hydrocarbon” generally refers to an organic compound having a vapor pressure of about 10 mm Hg at a temperature from about −250 to about −80 degrees Celsius. Non-limiting examples of gaseous compounds are organic compounds from about 1 to about 4 carbon atoms. Non-limiting examples of such organic compounds are methane, ethane, propane, n-butane, isobutane, ethylene, propylene, and 1-butene.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all the equivalents thereof. Further, the structures, materials or acts and the equivalents thereof shall include all those described in the summary of the invention, brief description of the drawings, detailed description, abstract, and claims themselves.

Unless otherwise noted, all component or composition levels are about the active portion of that component or composition and are exclusive of impurities, for example, residual solvents or by-products, which may be present in commercially available sources of such components or compositions.

Every maximum numerical limitation given throughout this disclosure is deemed to include each lower numerical limitation as an alternative, as if such lower numerical limitations were expressly written herein. Every minimum numerical limitation given throughout this disclosure is deemed to include each higher numerical limitation as an alternative, as if such higher numerical limitations were expressly written herein. Every numerical range given throughout this disclosure is deemed to include each narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The accompanying drawings are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples. Further features and advantages will become apparent from the following, more detailed, description of the various embodiments of the invention(s), as illustrated by the drawings referenced below.

FIG. 1 depicts a cross-section of a hydrocarbon-containing reservoir with the fluids omitted according to some embodiments of present disclosure;

FIG. 2 depicts a cross-section of a hydrocarbon-containing reservoir containing fluids according to some embodiments of the present disclosure;

FIG. 3 depicts a cross-section of a hydrocarbon-containing reservoir containing fluids according to some embodiments of the present disclosure;

FIG. 4 depicts a process according to some embodiments of the present disclosure; and

FIG. 5 depicts a cross-section of a hydrocarbon-containing reservoir containing fluids according to some embodiments of the present disclosure.

### DETAILED DESCRIPTION

These and other needs are addressed by the present disclosure.

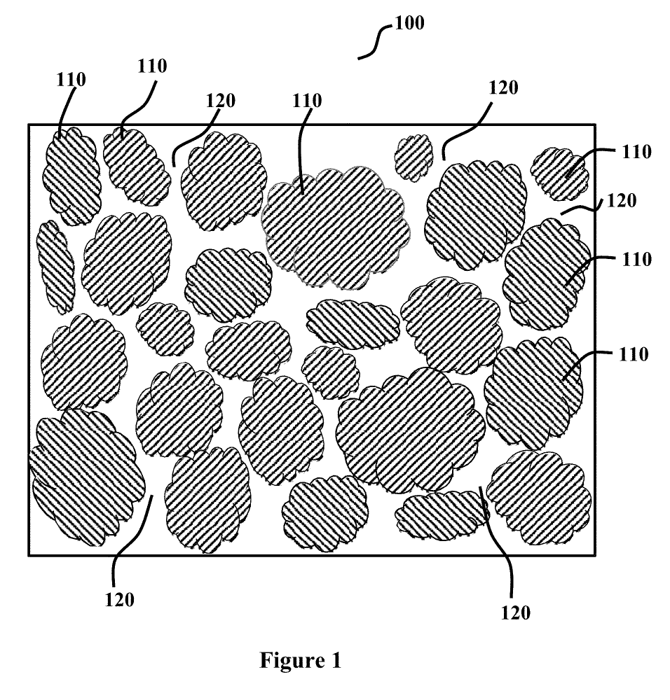

FIG. 1 depicts a cross-section of a hydrocarbon-containing reservoir 100 with the fluids omitted. The reservoir comprises a plurality of pore volumes 120 defined by reservoir mineral material 110. The hydrocarbon-containing reservoir can compose one or both of petroleum and gas.

A hydrocarbon-containing reservoir is generally considered to be one of water wet or hydrocarbon wet. More generally, a hydrocarbon-containing reservoir is water wet. In a water wet reservoir, water typically coats at least most, if not substantially all the surfaces comprising the pores. More typically, water coats at least about 50%, if not substantially about 100% of the pores surfaces comprising the water wet reservoir. The water is generally held in place by surface tension. As such, water coating the surface of the pores typically does not move while the hydrocarbon is being produced. It can be appreciated, that the production of the hydrocarbon can change the water saturation of the hydrocarbon-containing reservoir. The degree of change of the water saturation generally varies with the method of production of the hydrocarbon.

A hydrocarbon-containing reservoir generally comprises pores and one or more of a mean, mode and average pore volume, commonly referred to herein as reservoir pore volume. Moreover, the hydrocarbon-containing reservoir commonly has a porosity and permeability. Each pore generally contains a fluid. More generally, each pore contains one of water, hydrocarbon, or mixture thereof. Saturation of any fluid in a pore space is the ratio of the volume of the fluid to pore space volume. That is, the degree of water saturation of the hydrocarbon-containing reservoir generally expressed as the ratio of water volume to pore volume. For example, a water saturation of 25% corresponds to one-quarter of pore space being filled with water and the remaining 75% of the pore being with another fluid, such as a hydrocarbon liquid, hydrocarbon gas, or with a fluid other than water or hydrocarbon, such as carbon dioxide, nitrogen, or such. In some embodiments, the other fluid can be a provided hydrogen, that is a hydrocarbon gas introduced into the hydrocarbon-containing reservoir by injection through the wellhead. Hydrocarbon saturation is commonly expressed as ratio of hydrocarbon volume to pore volume, or more commonly as one minus the water saturation. The degree of water saturation can be calculated from the effective porosity and the resistivity logs.

Typically, water contained within a pore can be one of moveable water and substantially immoveable water. The substantially immoveable water comprises the water the wetting the surfaces of the pore volume. The wetted water is generally a film of water covering each pore surface. The substantially immoveable water contained in a hydrocarbon-containing reservoir is generally not withdrawn during production of the reservoir. Moveable water is the contained with the pore that is not wetting the surfaces of the pore volume. Moreover, the moveable water generally moves from one pore to another during production of the reservoir. As such, the moveable water can be in some instances produced during hydrocarbon production of the reservoir.

Moreover, the hydrocarbon-containing reservoir can have some degree of water saturation within reservoir pore network. While not wanting to be limited by example, the injection gas can comprise natural gas, nitrogen or in some cases air. When the hydrocarbon-containing reservoir is composed of high volumes of water, the hydrocarbons are generally disconnected and/or discontinuously distributed through the reservoir. The hydrocarbons commonly exist in the reservoir as one or more of hydrocarbon pockets or bubbles. The hydrocarbons are usually stranded in one or more pores and cracks within the reservoir. Moreover, water generally surrounds the one or more hydrocarbon pockets and bubbles.

Currently, the hydrocarbons and water are produced together. The mechanism of the co-production of the hydrocarbons and water is believed to work due to one or both water production carrying the hydrocarbons along with the water and production of water lowering the reservoir pressure causing hydrocarbons, particularly gaseous hydrocarbons, to expand to have one or more of pocket and/or bubbles coalesce to form a first continuous phase. In some cases, industry sees increasing gas to water volume to volume ratios under production of high volumes of water. This is due to the expansion behavior of gas compared to gas, hence the increase in the gas volume to water volume ratio over time as reservoir pressures drop.

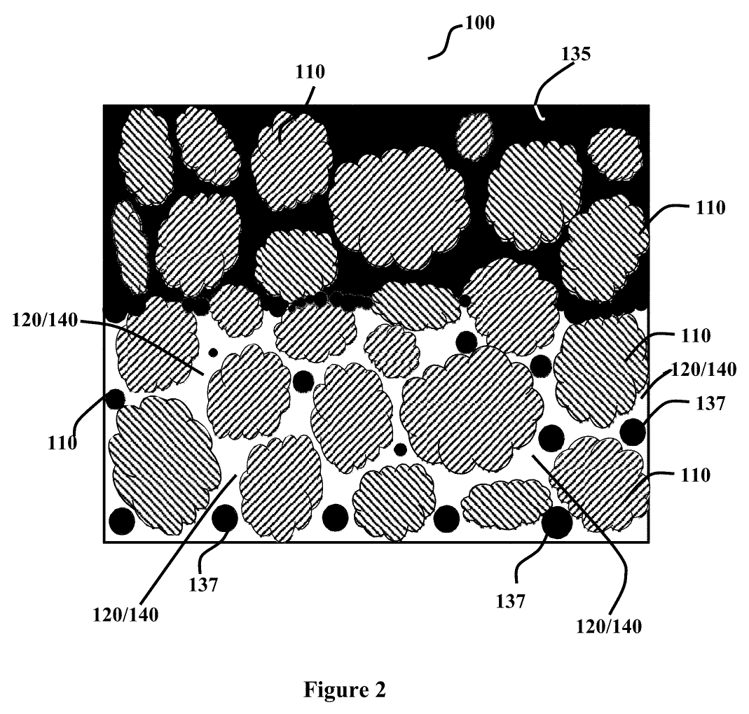

FIG. 2 depicts a cross-section of a hydrocarbon-containing reservoir 100 having a continuous hydrocarbon phase 135 and a plurality of discrete hydrocarbon phases 137. The continuous hydrocarbon phase 135 can be one or more of in contact with and span about four or more pore volumes 120. The discrete hydrocarbon phases 137 are generally dispersed in a continuous, moveable water phase 140. The continuous, moveable water phase 140 can be one or more of in contact with and span about four or more pore volumes 120. It can be appreciated that the continuous hydrocarbon phase 135 and the continuous, moveable hydrocarbon phases 137 are one or more in contact with and span different four or more pore volumes 120. Production of such a reservoir typically produces substantially water and substantially little, if any, hydrocarbon.

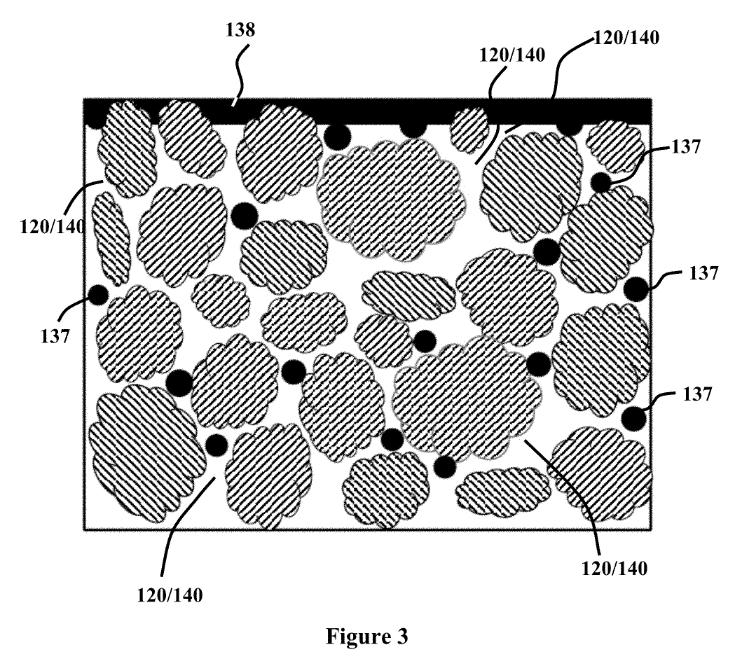

FIG. 3 depicts a cross-section of a hydrocarbon-containing reservoir 100 having a substantially depleted hydrocarbon continuous phase 138 and substantially comprising a plurality of discrete hydrocarbon phases 137. The plurality of discrete hydrocarbon phases 137 are typically dispersed in water saturated hydrocarbon reservoir. More typically, production from a water saturated hydrocarbon reservoir containing a plurality of discrete hydrocarbon phases 137 comprises substantially moveable saturated water 140. Even more typically, production from reservoirs with high moveable water saturation values can comprise substantially more water than hydrocarbons. In some embodiments, the hydrocarbon-containing reservoir 100 can commonly have a moveable water saturate level of from one of about 2% or more, more commonly of about 5% or more, even more commonly of about 10% or more, yet even more commonly of about 20% or more, still yet even more commonly about 30% or more, still yet even more commonly about 40% or more, still yet even more commonly about 50% or more, still yet even more commonly about 50% or more, or yet even more commonly about 60% or more to generally one of no more than about 10%, more generally of no more than about 20%, even more generally of no more than about 30%, yet even more generally of no more than about 40%, still yet even more generally of no more than about 50%, still yet even more generally of no more than about 60%, still yet even more generally of no more than about 70%, still yet even more generally of no more than about 80%, still yet even more generally of no more than about 90%, still yet even more generally of no more than about 92%, still yet even more generally of no more than about 95%, or yet still even more generally of no more than about 98%. Commonly, reservoirs having a high moveable water saturation value of one of between about 2%, more commonly about 5%, even more commonly about 10%, yet even more commonly about 15%, still yet even more commonly about 20%, still yet even more commonly about 25%, still yet even more commonly about 30%, still yet even more commonly about 35%, still yet even more commonly about 40%, still yet even more commonly about 45%, still yet even more commonly about 50%, still yet even more commonly about 55%, still yet or yet still even more commonly about 60% and one of typically about 15%, more typically about 20%, even more typically about 25%, yet even more typically about 30%, still yet even more typically about 35%, still yet even more commonly about 40%, still yet even more commonly about 45%, still yet even more commonly about 50%, still yet even more commonly about 55%, still yet even more commonly about 60%, still yet even more commonly about 65%, still yet even more commonly about 70%, still yet even more commonly about 75%, still yet even more commonly about 80%, still yet even more commonly about 85%, still yet even more commonly about 90%, still yet even more commonly about 95%, or still yet even more commonly about 98%.

In some embodiments, the hydrocarbon-containing reservoir 100 can usually have a hydrocarbon saturate level of from one of about 2% or more, more usually of about 5% or more, even more usually of about 10% or more, yet even more usually of about 20% or more, still yet even more usually about 30% or more, still yet even more usually about 40% or more, still yet even more usually about 50% or more, still yet even more usually about 50% or more, or yet even more usually about 60% or more to commonly one of no more than about 10%, more commonly of no more than about 20%, even more commonly of no more than about 30%, yet even more commonly of no more than about 40%, still yet even more commonly of no more than about 50%, still yet even more commonly of no more than about 60%, still yet even more commonly of no more than about 70%, still yet even more commonly of no more than about 80%, still yet even more commonly of no more than about 90%, still yet even more commonly of no more than about 92%, still yet even more commonly of no more than about 95%, or yet still even more commonly of no more than about 98%. Typically, the hydrocarbon-containing reservoirs having a hydrocarbon saturation value of one of between about 2%, more typically about 5%, even more typically about 10%, yet even more typically about 15%, still yet even more typically about 20%, still yet even more typically about 25%, still yet even more typically about 30%, still yet even more typically about 35%, still yet even more typically about 40%, still yet even more typically about 45%, still yet even more typically about 50%, still yet even more typically about 55%, still yet or yet still even more typically about 60% and one of generally about 15%, more generally about 20%, even more generally about 25%, yet even more generally about 30%, still yet even more generally about 35%, still yet even more typically about 40%, still yet even more generally about 45%, still yet even more generally about 50%, still yet even more generally about 55%, still yet even more generally about 60%, still yet even more generally about 65%, still yet even more generally about 70%, still yet even more generally about 75%, still yet even more generally about 80%, still yet even more generally about 85%, still yet even more generally about 90%, still yet even more generally about 95%, or still yet even more generally about 98%.

Commonly, such production on a mass-to-mass basis processes for each part of the discrete hydrocarbon phases 137 one part water, more commonly two parts water, even more commonly three parts water, yet even more commonly four parts water, still yet even more commonly five parts water, still yet even more commonly six parts water, still yet even more commonly seven parts water, still yet even more commonly eight parts water, still yet even more commonly nine parts water, still yet even more commonly ten parts water, still yet even more commonly eleven parts water, still yet even more commonly twelve parts water, still yet even more commonly thirteen parts water, still yet even more commonly fourteen parts water, still yet even more commonly fifteen parts water, still yet even more commonly sixteen parts water, still yet even more commonly seventeen parts water, still yet even more commonly eighteen parts water, still yet even more commonly nineteen parts water, still yet even more commonly twenty parts water, still yet even more commonly twenty-one parts water, still yet even more commonly twenty-two parts water, still yet even more commonly twenty-three parts water, still yet even more commonly twenty-four parts water, still yet even more commonly twenty-five parts water, still yet even more commonly twenty-six parts water, still yet even more commonly twenty-seven parts water, still yet even more commonly twenty-eight parts water, still yet even more commonly twenty-nine parts water, or yet still even more commonly thirty parts water.

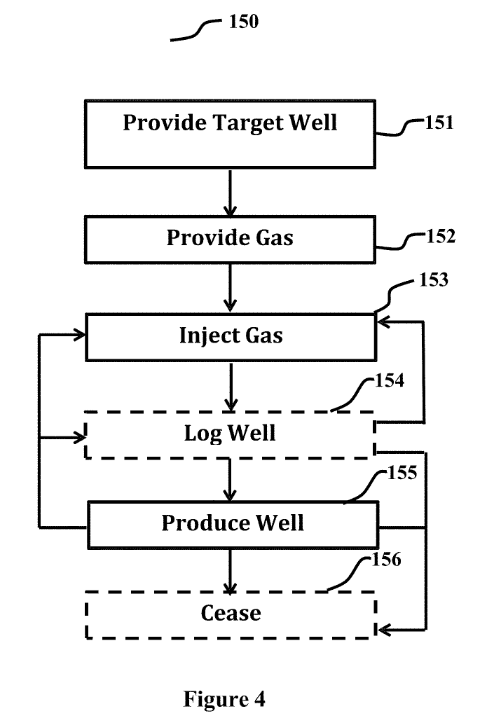

FIG. 4 depicts process 150 for treating a hydrocarbon-containing reservoir having a high moveable water saturation and a plurality of discrete hydrocarbon phases 137. In some embodiments, the plurality of discrete hydrocarbon phases 137 comprise short-chain hydrocarbons. The short-chain hydrocarbons can be without limitation straight or branched chain hydrocarbons having from about one to about six carbon atoms, more commonly from about one to about four carbon atoms, even more commonly from about one to about three carbon atoms, yet even more commonly from about one to about two carbon atoms, or still yet even more commonly about one carbon atom. In some embodiments, the short-chain hydrocarbons can be gaseous hydrocarbons. Non-limiting examples of gaseous hydrocarbons are methane, ethane, propane, n-butane, isobutane, ethylene, propylene, and 1-butene. Step 151 of process 150 can comprise providing and/or identifying a target well.

The target well generally traverses a hydrocarbon-containing reservoir having a high moveable water saturation and a plurality of discrete hydrocarbon phases 137. The target well can have a water to a gaseous hydrocarbon ratio. The target well typically can have a first water to gaseous hydrocarbon ratio.

In some embodiments, the first water to gaseous hydrocarbon ratio is generally one of its historical water to gaseous hydrocarbon production ratio or its original water to gaseous hydrocarbon ratio when it was originally put into production. Commonly, the first water to gaseous hydrocarbon ratio of the target well is one of about from about 10⁻³ to about 10³, more commonly from about 10⁻² to about 10³, even more commonly about 10⁻³ to about 10², yet even more commonly about 10⁻² to about 10², still yet even more commonly about 10⁻¹ to about 10², still yet even more commonly about 10⁻² to about 10¹, or yet still even more commonly about 10⁻¹ to about 10¹.

In some embodiments, the first water to gaseous hydrocarbon ratio is generally one of its historical water to gaseous hydrocarbon production ratio or its original water to gaseous hydrocarbon ratio when it was originally put into production. Commonly, the first water to gaseous hydrocarbon ratio of the target well is from one of about 1 bbl water per 1000 MCF gaseous hydrocarbon, more commonly of about 10 bbl water per 1000 MCF, even more commonly of about 20 bbl of water per 1000 MCF, yet even more commonly of about 50 bbl water per 1000 MCF, still yet even more commonly of about 100 bbl of water per 1000 MCF, still yet even more commonly of about 200 bbl of water per 1000 MCF, still yet even more commonly of about 500 bbl of water per 1000 MCF, or yet still even more commonly of about 1000 bbl of water per 1000 MCF of gaseous hydrocarbon to one of typically about 2000 bbl water per 1000 MCF gaseous hydrocarbon, more typically of about 1750 bbl water per 1000 MCF, yet even more typically of about 1500 bbl of water per 1000 MCF, still yet even more typically about 1250 bbl of water per 1000 MCF, still yet even more typically about 1o00 bbl of water per 1000 MCF, still yet even more typically about 500 bbl of water per 1000 MCF, still yet even more typically about 200 bbl of water per 1000 MCF, or yet still even more typically about 100 bbl of water per 1000 MCF of gaseous hydrocarbon.

It can be appreciated that the target well can be identified by one or more of its production and well log characteristics. For example, as described above, the target well produces substantially more water than hydrocarbons and has a well log indicating high levels of moveable water compared to hydrocarbon saturate levels as detailed above.

In step 152, the process 150 can include a step of providing a gas. The provided gas can be any gas. The provided gas can be substantially a single chemical composition or a mixture of chemical compositions. Moreover, the provided gas can be an inorganic composition, an organic composition, a mixture of inorganic compositions, a mixture of organic compositions, or combinate of inorganic and organic compositions. In accordance with some embodiments of the disclosure, the provided gas can be an inert gas. In accordance with some embodiments of the disclosure, the provided gas can be nitrogen (N₂). In accordance with some embodiments of the disclosure, the provided gas can be hydrogen (H₂). In accordance with some embodiments of the disclosure, the provided gas can be methane (CH₄). In accordance with some embodiments of the disclosure, the provided gas can be ethane (CH₃—CH₃). In accordance with some embodiments of the disclosure, the provided gas can be propane (C₃H₈). In accordance with some embodiments of the disclosure, the provided gas can be butane (C₄H₁₀). In accordance with some embodiments of the disclosure, the provided gas can be carbon dioxide (CO₂). In accordance with some embodiments of the disclosure, the provided gas can be one or more of nitrogen (N₂), hydrogen (H₂), methane (CH₄), ethane (CH₃—CH₃), propane (C₃H₈), butane (C₄H₁₀), carbon dioxide (CO₂), and inert gas. Moreover, while not wanting to be limited by example, the provided gas can be in some embodiments air, oxygen, nitrogen, an inert gas, carbon dioxide, methane, ethane, propane, iso-propane, butane, isobutane, t-butane, pentane, iso-pentane, t-pentane, or a mixture thereof. The provided gas can be provided by a commercial source, a subterranean source, an atmospheric source, or a combination thereof. In accordance with some embodiments, an injection gas (such as, but not limited to methane or methane and an associated hydrocarbon) can be injected into a hydrocarbon-containing reservoir.

In step 153, the provided gas can be injected into the target well. The target well can traverse a subterranean hydrocarbon-containing reservoir 100. Moreover, the provided gas can be injected into the subterranean hydrocarbon-containing reservoir 100. In accordance with some embodiments of the disclosure, the injection step 153 can include the provided gas being in the gas phase during the injection of the gas into the wellbore. A person of ordinary skill in the art would generally consider the process 100 described herein of injecting a provided gas into a water saturated hydrocarbon-containing reservoir counter-intuitive. More specifically, a person of ordinary skill in the art would consider injecting a provided gas into a water saturated hydrocarbon-containing reservoir to one or both of dewater the reservoir and improve hydrocarbon recovery from the reservoir.

In accordance with some embodiments of the disclosure, the injection step 153 can include the provided gas being in the liquid phase when being injected into the wellbore. In accordance with some embodiments of the disclosure, the injection step 153 can include the provided gas being in the form of a foam when being injected into the wellbore. Moreover, in accordance with some embodiments of the disclosure, the injection step 153 can include the provided gas being in the form of one or more of gas phase, liquid phase, foam, or combination thereof when being injected into the wellbore. In some embodiments, the foam can be more gas by volume than liquid by volume. Moreover, in some embodiments the foam can have no more than about 50 volume % liquid. Furthermore, in accordance with some embodiments, the foam can have less gas by volume than liquid by volume.

The subterranean hydrocarbon-containing reservoir 100 generally comprises a reservoir having a high moveable water saturation and a plurality of discreet hydrocarbon phases 137 for a period. Typically, the provided gas can be injected into the subterranean hydrocarbon-containing reservoir 100 at a rate of from one of about 10 mcfd or more, more typically at a rate of about 20 mcfd or more, even more typically at a rate of about 30 mcfd or more, yet even more typically at a rate of about 40 mcfd or more, still yet even more typically at a rate of about 50 mcfd or more, still yet even more typically at a rate of about 60 mcfd or more, still yet even more typically at a rate of about 70 mcfd or more, still yet even more typically at a rate of about 80 mcfd or more, still yet even more typically at a rate of about 90 mcfd or more, still yet even more typically at a rate of about 100 mcfd or more, still yet even more typically at a rate about 110 mcfd or more, still yet even more typically at a rate least about 120 mcfd or more, still yet even more typically at a rate of about 130 mcfd or more, still yet even more typically at a rate of about 140 mcfd or more, still yet even more typically at a rate of about 150 mcfd or more, still yet even more typically at a rate of about 160 mcfd or more, still yet even more typically at a rate of about 170 mcfd or more, still yet even more typically at a rate of about 180 mcfd or more, still yet even more typically at a rate of about 190 mcfd or more, still yet even more typically at a rate of about 200 mcfd or more, still yet even more typically at a rate of about 210 mcfd or more, still yet even more typically at a rate of about 220 mcfd or more, still yet even more typically at a rate of about 230 mcfd or more, still yet even more typically at a rate of about 240 mcfd or more, still yet even more typically at a rate of about 250 mcfd or more, still yet even more typically at a rate of about 260 mcfd or more, still yet even more typically at a rate of about 270 mcfd or more, still yet even more typically at a rate of about 280 mcfd or more, still yet even more typically at a rate of about 290 mcfd or more, still yet even more typically at a rate of about 300 mcfd or more, still yet even more typically at a rate of about 310 mcfd or more, still yet even more typically at a rate of about 320 mcfd or more, still yet even more typically at a rate of about 330 mcfd or more, still yet even more typically at a rate of about 340 mcfd or more, still yet even more typically at a rate of about 350 mcfd or more, still yet even more typically at a rate of about 360 mcfd or more, still yet even more typically at a rate of about 370 mcfd or more, still yet even more typically at a rate of about 380 mcfd or more, still yet even more typically at a rate of about 390 mcfd or more, still yet even more typically at a rate of about 400 mcfd or more, still yet even more typically at a rate of about 410 mcfd or more, still yet even more typically at a rate of about 420 mcfd or more, still yet even more typically at a rate of about 430 mcfd or more, still yet even more typically at a rate of about 440 mcfd or more, still yet even more typically at a rate of about 450 mcfd or more, still yet even more typically at a rate of about 460 mcfd or more, still yet even more typically at a rate of about 470 mcfd or more, still yet even more typically at a rate of about 480 mcfd or more, still yet even more typically at a rate of about 490 mcfd or more, still yet even more typically at a rate of about 500 mcfd or more, still yet even more typically at a rate of about 510 mcfd or more, still yet even more typically at a rate of about 520 mcfd or more, still yet even more typically at a rate of about 530 mcfd or more, still yet even more typically at a rate of about 540 mcfd or more, still yet even more typically at a rate of about 550 mcfd or more, still yet even more typically at a rate of about 560 mcfd or more, still yet even more typically at a rate of about 570 mcfd or more, still yet even more typically at a rate of about 580 mcfd or more, still yet even more typically at a rate of about 590 mcfd or more, still yet even more typically at a rate least about 600 mcfd or more, still yet even more typically at a rate of about 610 mcfd or more, still yet even more typically at a rate of about 620 mcfd or more, still yet even more typically at a rate of about 630 mcfd or more, still yet even more typically at a rate of about 640 mcfd or more, still yet even more typically at a rate of about 650 mcfd or more, still yet even more typically at a rate of about 660 mcfd or more, still yet even more typically at a rate of about 670 mcfd or more, still yet even more typically at a rate of about 680 mcfd or more, still yet even more typically at a rate of about 690 mcfd or more, still yet even more typically at a rate of about 700 mcfd or more, still yet even more typically at a rate of about 710 mcfd or more, still yet even more typically at a rate of about 720 mcfd or more, still yet even more typically at a rate of about 730 mcfd or more, still yet even more typically at a rate of about 740 mcfd or more, still yet even more typically at a rate of about 750 mcfd or more, still yet even more typically at a rate of about 760 mcfd or more, still yet even more typically at a rate of about 770 mcfd or more, still yet even more typically at a rate of about 780 mcfd or more, still yet even more typically at a rate of about 790 mcfd or more, still yet even more typically at a rate of about 800 mcfd or more, still yet even more typically at a rate of about 810 mcfd or more, still yet even more typically at a rate of about 820 mcfd or more, still yet even more typically at a rate of about 830 mcfd or more, still yet even more typically at a rate of about 840 mcfd or more, still yet even more typically at a rate of about 850 mcfd or more, still yet even more typically at a rate of about 860 mcfd or more, still yet even more typically at a rate of about 870 mcfd or more, still yet even more typically at a rate of about 880 mcfd or more, still yet even more typically at a rate of about 890 mcfd or more, still yet even more typically at a rate of about 900 mcfd or more, still yet even more typically at a rate of about 910 mcfd or more, still yet even more typically at a rate of about 920 mcfd or more, still yet even more typically at a rate of about 930 mcfd or more, still yet even more typically at a rate of about 940 mcfd or more, still yet even more typically at a rate of about 950 mcfd or more, still yet even more typically at a rate of about 960 mcfd or more, still yet even more typically at a rate of about 970 mcfd or more, still yet even more typically still yet even more typically at a rate of about 980 mcfd or more, still yet even more typically at a rate of about 990 mcfd or more, yet still even more typically at a rate of about 1,000 mcfd or more, to one of commonly no more than about more commonly at a rate of no more than about 20 mcfd, even more commonly at a rate of no more than about 30 mcfd, yet even more commonly at a rate of no more than about 40 mcfd, still yet even more commonly at a rate of no more than about 50 mcfd, still yet even more commonly at a rate of no more than about 60 mcfd, still yet even more commonly at a rate of no more than about 70 mcfd, still yet even more commonly at a rate of no more than about 80 mcfd, still yet even more commonly at a rate of no more than about 90 mcfd, still yet even more commonly at a rate of no more than about 100 mcfd, still yet even more commonly at a rate about 110 mcfd, still yet even more commonly at a rate least about 120 mcfd, still yet even more commonly at a rate of no more than about 130 mcfd, still yet even more commonly at a rate of no more than about 140 mcfd, still yet even more commonly at a rate of no more than about 150 mcfd, still yet even more commonly at a rate of no more than about 160 mcfd, still yet even more commonly at a rate of no more than about 170 mcfd, still yet even more commonly at a rate of no more than about 180 mcfd, still yet even more commonly at a rate of no more than about 190 mcfd, still yet even more commonly at a rate of no more than about 200 mcfd, still yet even more commonly at a rate of no more than about 210 mcfd, at a rate of no more than about 220 mcfd, still yet even more commonly at a rate of no more than about 230 mcfd, still yet even more commonly at a rate of no more than about 240 mcfd, at a rate of no more than about 250 mcfd, still yet even more commonly at a rate of no more than about 260 mcfd, still yet even more commonly at a rate of no more than about 270 mcfd, still yet even more commonly at a rate of no more than about 280 mcfd, still yet even more commonly at a rate of no more than about 290 mcfd, still yet even more commonly at a rate of no more than about 300 mcfd, still yet even more commonly at a rate of no more than about 310 mcfd, still yet even more commonly at a rate of no more than about 320 mcfd, still yet even more commonly at a rate of no more than about 330 mcfd, still yet even more commonly at a rate of no more than about 340 mcfd, still yet even more commonly at a rate of no more than about 350 mcfd, at a rate of no more than about 360 mcfd, still yet even more commonly at a rate of no more than about 370 mcfd, at a rate of no more than about 380 mcfd, at a rate of no more than about 390 mcfd, still yet even more commonly at a rate of no more than about 400 mcfd, at a rate of no more than about 410 mcfd, still yet even more commonly at a rate of no more than about 420 mcfd, still yet even more commonly at a rate of about 430 mcfd, still yet even more commonly at a rate of no more than about 440 mcfd, at a rate of no more than about 450 mcfd, still yet even more commonly at a rate of no more than about 460 mcfd, still yet even more commonly at a rate of no more than about 470 mcfd, still yet even more commonly at a rate of no more than about 480 mcfd, still yet even more commonly at a rate of no more than about 490 mcfd, still yet even more commonly at a rate of no more than about 500 mcfd, still yet even more commonly at a rate of no more than about 510 mcfd, still yet even more commonly at a rate of no more than about 520 mcfd, still yet even more commonly at a rate of no more than about 530 mcfd, still yet even more commonly at a rate of no more than about 540 mcfd, still yet even more commonly at a rate of no more than about 550 mcfd, at a rate of no more than about 560 mcfd, at a rate of no more than about 570 mcfd, still yet even more commonly at a rate of no more than about 580 mcfd, still yet even more commonly at a rate of no more than about 590 mcfd, still yet even more commonly at a rate least about 600 mcfd, still yet even more commonly at a rate of no more than about 610 mcfd, still yet even more commonly at a rate of no more than about 620 mcfd, still yet even more commonly at a rate of no more than about 630 mcfd, still yet even more commonly at a rate of no more than about 640 mcfd, still yet even more commonly at a rate of no more than about 650 mcfd, still yet even more commonly at a rate of no more than about 660 mcfd, still yet even more commonly at a rate of no more than about 670 mcfd, still yet even more commonly at a rate of no more than about 680 mcfd, at a rate of no more than about 690 mcfd, at a rate of no more than about 700 mcfd, still yet even more commonly at a rate of no more than about 710 mcfd, at a rate of no more than about 720 mcfd, at a rate of no more than about 730 mcfd, still yet even more commonly at a rate of no more than about 740 mcfd, still yet even more commonly at a rate of no more than about 750 mcfd, still yet even more commonly at a rate of no more than about 760 mcfd, still yet even more commonly at a rate of no more than about 770 mcfd, still yet even more commonly at a rate of no more than about 780 mcfd, still yet even more commonly at a rate of no more than about 790 mcfd, still yet even more commonly at a rate of no more than about 800 mcfd, still yet even more commonly at a rate of no more than about 810 mcfd, still yet even more commonly at a rate of no more than about 820 mcfd, still yet even more commonly at a rate of no more than about 830 mcfd, still yet even more commonly at a rate of no more than about 840 mcfd, still yet even more commonly at a rate of no more than about 850 mcfd, still yet even more commonly at a rate of no more than about 860 mcfd, still yet even more commonly at a rate of no more than about 870 mcfd, still yet even more commonly at a rate of no more than about 880 mcfd, still yet even more commonly at a rate of no more than about 890 mcfd, still yet even more commonly at a rate of no more than about 900 mcfd, still yet even more commonly at a rate of no more than about 910 mcfd, still yet even more commonly at a rate of no more than about 920 mcfd, still yet even more commonly at a rate of no more than about 930 mcfd, still yet even more commonly at a rate of no more than about 940 mcfd, still yet even more commonly at a rate of no more than about 950 mcfd, still yet even more commonly at a rate of no more than about 960 mcfd, at a rate of no more than about 970 mcfd, still yet even more commonly at a rate of no more than about 980 mcfd, still yet even more commonly at a rate of no more than about 990 mcfd, still yet even more commonly at a rate of no more than about 1,000 mcfd, still yet even more commonly at a rate of no more than about 1,100 mcfd, still yet even more commonly at a rate of no more than about 1,250 mcfd, still yet even more commonly at a rate of no more than about 1,500 mcfd, still yet even more commonly at a rate of no more than about 2,000 mcfd, still yet even more commonly at a rate of no more than about 2,500 mcfd, still yet even more commonly at a rate of no more than about 3,000 mcfd, still yet even more commonly at a rate of no more than about 3,500 mcfd, still yet even more commonly at a rate of no more than about 4,000 mcfd, still yet even more commonly at a rate of no more than about 4,500 mcfd, still yet even more commonly at a rate of no more than about 5,000 mcfd, still yet even more commonly at a rate of no more than about 5,500 mcfd, still yet even more commonly at a rate of no more than about 6,000 mcfd, still yet even more commonly at a rate of no more than about 6,500 mcfd, still yet even more commonly at a rate of no more than about 7,000 mcfd, still yet even more commonly at a rate of no more than about 7,500 mcfd, or yet still even more commonly at a rate of no more than about 8,000 mcfd.

In some embodiments of the present disclosure, the provided gas is usually injected at a pressure below the reservoir fracture gradient pressure. Injection period will be for about three months, more typically between three months and three years. In some embodiments, the injection period is more than about 5 days but less than about three months. In some embodiments, the injection period is selected from the group of about 5 days, about 10 days, about 15 days, about 30 days, about 45 days, about 60 days, about 75 days, about 90, or any combination thereof. In some embodiments, the provided gas can be injected for a period of about one day. More commonly, the provided gas can be injected one of for a period of time of more than about one day but less than about one week, even more commonly for a period of time of more than about one week but less than about one month, yet even more commonly for a period of time of more than about one month but less than about three months, still yet even more commonly for a period of time of more than two months but less than about 6 months, still yet even more commonly for a period of time of more than three months but less than about one year, still yet even more commonly for a period of more than about 6 months but less than about 18 months, still yet even more commonly for a period of time more than about 18 months but less than about 24 months, still yet even more commonly for a period of more than about 18 months but less than 36 months, still yet even more commonly for a period of time of more than about two years but less than about four years, or yet still even more commonly for a period of more than about three years but less than about 10 years.

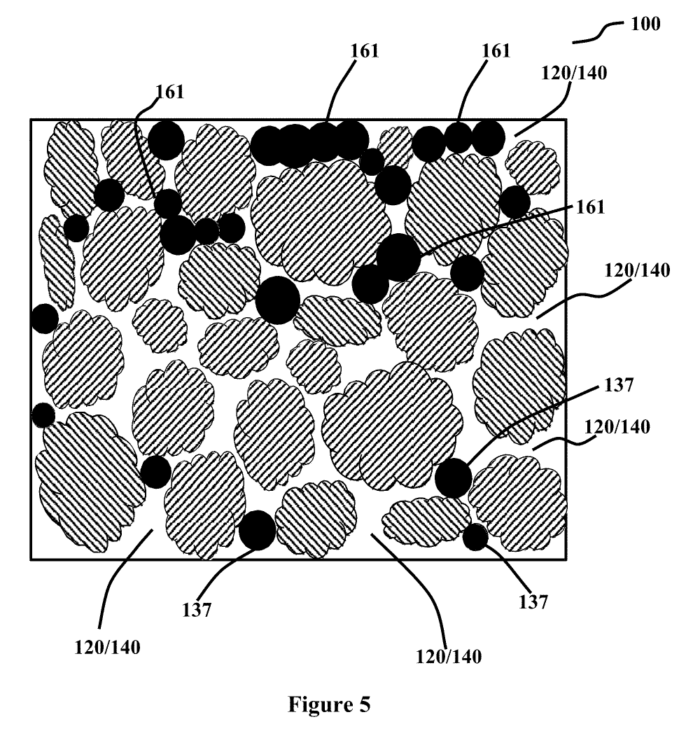

While not wanting to be bound by any theory, it is believed that the injection of the provided gas into the hydrocarbon-containing reservoir can coalesce one or more of the plurality of discrete hydrocarbon phases 137 in the reservoir to form one or more continuous hydrocarbon phases 161, see FIG. 5. It can be appreciated that as the injection of the provided gas in step 153 is maintained, the one or more the plurality of discrete hydrocarbon phases 137 can continue to coalesce. In accordance with some embodiments, the plurality of discrete hydrocarbon phases 137 can be in the form one or more of pockets and bubbles of hydrocarbons. Moreover, these one or more pockets and bubbles of hydrocarbons can continue coalesce to form the continuous hydrocarbon phases 161 of hydrocarbons. It can be appreciated that the continuous hydrocarbon phases 161 can comprise one or more of hydrocarbon gas and petroleum. While not wanting to be limited by theory, it is believed that once a more continuous hydrocarbon phase 161 is formed within the reservoir, the hydrocarbons along with the provided gas can flow toward the wellbore.

Injection of the provided gas into the reservoir, in step 153, can imbibe the injected gas into the pore volumes 120. It can be appreciated that the pore volumes comprise a network of pores within the reservoir. Moreover, the network of pores within the reservoir have a porosity and permeability. As used herein, porosity generally relates to void spaces in the subterranean hydrocarbon-containing reservoir 100 that can hold fluids. As used herein, permeability generally relates to a characteristic of the subterranean hydrocarbon-containing reservoir 100 that fluid to through the rock. As can be appreciated, permeability is generally a measure of the interconnectivity of the void spaces (porosity) and their size.

The provided gas (and other hydrocarbons that can be contained within the provided gas) can imbibe the hydrocarbon-containing reservoir. Moreover, the provided gas (and other hydrocarbons) can coalesce with the hydrocarbons contained in the hydrocarbon-containing reservoir to form a one or more continuous hydrocarbon phases 161 within the reservoir.

While not wanting to be limited by theory, it is believed that the one or more continuous hydrocarbon phases 161 commonly span two or more pore volumes 120 defined by the reservoir materials 110, more commonly three or more pore volumes 120, or even more commonly four or more pore volumes 120. This is generally in contrast to the each of the plurality of discrete hydrocarbon phases 137 which typically occupy a single pore volume 120. It can be appreciated that one or more continuous hydrocarbon phases 161 comprise the provided gas and the hydrocarbon(s) comprising the plurality of discrete hydrocarbon phases 137. The injection of the provided gas can increase the degree of hydrocarbon saturation of the hydrocarbon-containing reservoir. Moreover, the injection of the provided gas into the reservoir generally decreases the degree of water saturation of hydrocarbon-containing reservoir.

After a period of time of injecting the provided gas (in step 153), the target well can be logged in step 154. In some embodiments, the target well is not logged but put into production, step 155, after a targeted volume of the provided gas has been injected. Typically, production step 155 comprises reversing flow of the target well. That is, the injection step 153 is ceased and the flow of gas is reversed from injecting to producing. The production step 155 generally includes gathering from the subterranean hydrocarbon-containing reservoir 100 the injected provided gas and the hydrocarbons contained within the hydrocarbon-containing reservoir. Management of the production step 155 generally depends on reservoir rock properties and conditions. It can be appreciated that the flow of the hydrocarbons towards the wellbore resumes producing operations of the target well.

In some embodiments, if the well log indicates that the level moveable water saturation has decreased commonly by an amount of one of about 10%, more commonly by about 20%, even more commonly by about 30%, yet even more commonly by about 40%, still yet more commonly by about 50%, still yet more commonly by about 60%, still yet more commonly by about 70%, still yet more commonly by about 80%, still yet more commonly by about 90% or yet still more commonly by about 95% or more, the well can be put into production, step 155. In some embodiments, the well log can indicate the level of moveable water saturation has decreased by generally by amount from about one of about 5% or more, more generally of about 10% or more, even more generally of about 15% or more, yet even more generally of about 20% or more, still yet even more generally about 25% or more, still yet even more generally about 30% or more, still yet even more generally about 40% or more, still yet even more generally about 50% or more, or yet even more generally about 60% or more to typically one of no more than about 10%, more typically of no more than about 20%, even more typically of no more than about 30%, yet even more typically of no more than about 40%, still yet even more typically of no more than about 50%, still yet even more typically of no more than about 60%, still yet even more typically of no more than about 70%, still yet even more typically of no more than about 80%, still yet even more typically of no more than about 90%, still yet even more typically of no more than about 92%, still yet even more typically of no more than about 95%, or yet still even more typically of no more than about 98%. Generally, it is believed that the decrease in moveable water saturation can increase the production of hydrocarbons, such as, not limited to gaseous hydrocarbons. More generally, it is believed that the decrease in moveable water saturation can increase the production of gaseous hydrocarbons, such as, but not limited to gaseous hydrocarbons commonly comprising from one of from one to four carbon atoms, more commonly from about one to about three carbon atoms, even more commonly from about one to about two carbon atoms, or yet even more commonly substantially comprising hydrocarbons substantially comprising methane.

In some embodiments, the well long indicates that the level hydrocarbon saturation has increased generally by an amount, compared to its initial hydrocarbon saturation level prior to the injection of the provided gas, of one of about 10%, more generally by about 20%, even more generally by about 30%, yet even more general by about 40%, still yet even more generally by about 50%, still yet even more generally by about 60%, still yet even more generally by about 70%, still yet even more generally by about 80%, still yet even more generally by about 90%, still yet even more generally by about 100%, still yet even more generally by about 110%, still yet even more generally by about 125%, or yet still even more generally by about 130% or more. In some embodiments, the well long indicates that the level hydrocarbon saturation has increased typically by an amount, compared to its initial hydrocarbon saturation level prior to the injection of the provided gas, from one of about 5%, more typically 10%, even more typically about 15%, yet even more typically about 20%, still yet even more typically about 25%, still yet even more typically about 30%, still yet even more typically about 35%, still yet even more typically about 40%, still yet even more typically about 45%, still yet even more typically about 50%, still yet even more typically about 55%, still yet even more typically about 55%, still yet even more typically about 65%, still yet even more typically about 65%, still yet even more typically about 70%, still yet even more typically about 75%, still yet even more typically about 80%, still yet even more typically about 85%, still yet even more typically about 90%, still yet even more typically about 100%, still yet even more typically about 125%, still yet even more typically about 150%, still yet even more typically about 175%, or yet still even more typically about 200% to one of generally about 10%, even more generally about 20%, yet even more generally about 30%, still yet even more generally about 40%, still yet even more generally about 50%, still yet even more generally about 60%, still yet even more generally about 70%, still yet even more generally about 80%, still yet even more generally about 90%, still yet even more generally about 100%, still yet even more generally about 125%, still yet even more generally about 150%, still yet even more generally about 175%, still yet even more generally about 200%, still yet even more generally about 250%, still yet even more generally about 300%, still yet even more generally about 350%, still yet even more generally about 400%, still yet even more generally about 450%, still yet even more generally about 500%, still yet even more generally about 550%, still yet even more generally about 600%, or yet still even more generally about 700%.

The well can be put into production, step 155. The target well, after the injection of provided gas, generally can have a second water to gaseous hydrocarbon ratio. The second water to gaseous hydrocarbon ratio is generally less than the first water to gaseous hydrocarbon ratio. Commonly, the second water to gaseous hydrocarbon ratio is typically from about one of no more than about 98% of the first water to gaseous hydrocarbon ratio, more typically no more than about 95%, even more typically no more than about 90%, yet even more typically no more than about 85%, still yet even more typically no more than about 80%, still yet even more typically no more than about 75%, still yet even more typically no more than about 60%, still yet even more typically no more than about 55%, still yet even more typically no more than about 50%, still yet even more typically no more than about 45%, or yet still even more typically no more than about 40% of the first water to gaseous hydrocarbon ratio to one of commonly about 2% or more of the first water to gaseous hydrocarbon ratio, more commonly about 5% or more, even more commonly about 10% or more, yet even more commonly about 15% or more, still yet even more commonly about 20% or more, still yet even more commonly about 25% or more, still yet even more commonly about 30% or more, still yet even more commonly about 35% or more, still yet even more commonly about 40% or more, still yet even more commonly about 45% or more, still yet even more commonly about 50% or more, still yet even more commonly about 55% or more, still yet even more commonly about 60% or more, still yet even more commonly about 65% or more, still yet even more commonly about 70% or more, still yet even more commonly about 75% or more, still yet even more commonly about 80% or more, still yet even more commonly about 85% or more, or yet still even more commonly about 90% or more of the first water to gaseous hydrocarbon ratio.

It is commonly believed that the increase in hydrocarbon saturation can increase the production of hydrocarbons, such as, not limited to gaseous hydrocarbons. More commonly, it is believed that the increase in hydrocarbon saturation can increase the production of gaseous hydrocarbons, such as, but not limited to gaseous hydrocarbons generally comprising from one of from one to four carbon atoms, more generally from about one to about three carbon atoms, even more generally from about one to about two carbon atoms, or yet even more generally substantially comprising hydrocarbons substantially comprising methane.

If the well log does not indication that one or more of that the level of moveable water saturation has substantially decreased, the level of hydrocarbon saturation has substantially increased sufficiently or a combination thereof, the injection of the provided gas in step 153 can be continued or the process 150 can be ceased.

Hydrocarbon production, step 155, can be continued until one or more of the following is true: (a) the well ceases to produce any more hydrocarbons; (b) the level of water production becomes unsatisfactory; and (c) the hydrocarbon-containing reservoir becomes water saturated again. In some embodiments, if one or more of (a), (b) or (c) are true, process 150 can be ceased, step 156. In some embodiments, if one or more of (a), (b) or (c) are true, the provided gas injection step 153 can be reinitiated. In some embodiments, if one or more of (a), (b) or (c) are true the well can be logged again to determine one or more of the moveable water and hydrocarbon saturation levels. If the hydrocarbon saturation level indicates sufficient hydrocarbons are available for recovery, the provided gas injection step can be reinitiated.

It is believed that the injection of the provided gas into the hydrocarbon-containing reservoir to coalesce one or more of the plurality of discrete hydrocarbon phases 137 in the reservoir to form one or more continuous hydrocarbon phases 161 differs from the injection of carbon dioxide or other similar gas to lower the viscosity of entrained hydrocarbons. The injection of the provided gas and coalesce of the one or more of the plurality of discrete hydrocarbon phases 137 is not believed to be due to change in viscosity of the discrete hydrocarbon phases 157. What, if any change, in the viscosity of the injected provided gas, the discreet hydrocarbon phases 157 and the one or more continuous hydrocarbon phases 161 are believe negligible.

The present disclosure, in various aspects, embodiments, and configurations, includes components, methods, processes, systems and/or apparatus substantially as depicted and described herein, including various aspects, embodiments, configurations, sub-combinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. A method, comprising:
providing a gas;
injecting the provided gas into a hydrocarbon-containing reservoir having a first water-to-gas production ratio, wherein the hydrocarbon-containing reservoir comprises a gaseous hydrocarbon, wherein the provided gas is injected at rate of from about 10 mcfd or more to about no more than about 8,000 mcfd;
ceasing the injection of the provided gas; and
gathering from the hydrocarbon-containing reservoir a gathered-gas mixture comprising the provided gas and some of the gaseous hydrocarbons from the hydrocarbon-containing reservoir, wherein the hydrocarbon-containing reservoir producing the gathered-gas mixture has a second water-to-gas production ratio and wherein the second water-to-gas ratio is no more than the first water-to-gas ratio.

2. The method of claim 1, wherein the provided gas injected into the hydrocarbon-containing reservoir is selected from the group consisting essentially of methane, ethane, propane, nitrogen, butane, air, oxygen, argon, carbon dioxide, helium or mixture thereof.

3. The method of claim 1, wherein, prior to the injecting of the provided gas, the hydrocarbon-containing reservoir comprises a plurality of discrete hydrocarbon phases, wherein the plurality of discrete hydrocarbon phases is in the form of one or more pockets and bubbles of hydrocarbons, wherein the injecting of the provided gas coalesces the one or more of the plurality of discrete hydrocarbon phases into one or more continuous hydrocarbon phases.

4. The method of claim 1, wherein the gather gas mixture comprises the provided gas and the gaseous hydrocarbons having from about 2 to about 98 volume % the provided gas and from about 98 to about 2 volume % the gaseous hydrocarbon.

5. The method of claim 1, wherein the gaseous hydrocarbon comprises one of methane, ethane, propane, n-butane, isobutane, ethylene, propylene, 1-butene, and mixture thereof.

6. The method of claim 1, wherein the first water to gaseous hydrocarbon is from about 1 bbl water/1000 MCF to about 2000 bbl water/1000 MCF.

7. The method of claim 1, wherein the second water to gaseous hydrocarbon ratio is from about 98% to about 2% of first water to gaseous hydrocarbon ratio.

8. The method of claim 1, wherein the injecting of the provided gas is for a period from about five days to about three months.

9. The method of claim 1, wherein the gaseous hydrocarbon gas comprises methane.

10. A method, comprising:
providing a well having first water to gas production ratio;
providing a gas;
injecting the provided gas into a well bore, wherein the wellbore traverses a hydrocarbon-containing reservoir, wherein the hydrocarbon-containing reservoir comprises a gaseous hydrocarbon;
ceasing the injection of the provided gas; and
producing from the wellbore a mixture of the provided gas and some of the gaseous hydrocarbons having a second water to gas production ratio, wherein the first water-to-gas ratio is greater than the second water-to-gas ratio.

11. The method of claim 10, wherein the hydrocarbon-containing reservoir comprises pore volumes having a porosity and permeability, and wherein, prior to the injecting of the provided gas, the hydrocarbon-containing reservoir comprises a plurality of discrete hydrocarbon phases contained within the pore volumes and wherein the injecting of the provided gas coalesces the one or more of the plurality of discrete hydrocarbon phases into one or more continuous hydrocarbon phases, and wherein the one or more continuous hydrocarbon phases span three or more pore volumes.

12. The method of claim 11, wherein the gaseous hydrocarbon comprises one of methane, ethane, propane, n-butane, isobutane, ethylene, propylene, 1-butene, and mixture thereof.

13. The method of claim 10, wherein the first water to gaseous hydrocarbon is from about 1 bbl water/1000 MCF to about 2000 bbl water/1000 MCF.

14. The method of claim 10, wherein the provided gas injected into the hydrocarbon-containing reservoir is one of methane, ethane, propane, nitrogen, butane, air, oxygen, argon, carbon dioxide, helium or mixture thereof.

15. The method of claim 10, wherein the injecting of the provided gas into the wellbore is at a pressure below the fracture press of the hydrocarbon-containing reservoir.

16. The method of claim 10, wherein the second water to gaseous hydrocarbon ratio is from about 98% to about 2% of first water to gaseous hydrocarbon ratio.

17. The method of claim 10, wherein the mixture of the provided gas and some of the gaseous hydrocarbons comprises from about 2 to about 98 volume % the provided gas and from about 98 to about 2 volume % the gaseous hydrocarbon.

18. The method of claim 10, wherein the injecting of the provided gas is for a period from about five days to about three months.

19. A method, comprising:
providing a target well having a first water to gas production ratio from about 1 bbl water/1000 MCF to about 2000 bbl water/1000 MCF;
providing a gas;
injecting the provided gas into a well bore, wherein the wellbore traverses the hydrocarbon-containing reservoir, wherein the provided gas is injected at a rate of from about 10 mcfd or more to about no more than about 8,000 mcfd; and
producing, after the ceasing of the injection of the provided gas, from the target well at a second water to gaseous hydrocarbon ration, wherein the second water to gaseous hydrocarbon ratio is from about 98% to about 2% of first water to gas production ratio.

20. The method of claim 19, wherein the provided gas injected into the hydrocarbon-containing reservoir is one of methane, ethane, propane, nitrogen, butane, air, oxygen, argon, carbon dioxide, helium or mixture thereof and wherein the injecting of the provided gas into the wellbore is at a pressure below the fracture press of the hydrocarbon-containing reservoir.
